(19) United States
(12) Patent Application Publication
(10) Pub. No.: US 2022/0297122 A1
(43) Pub. Date: Sep. 22, 2022

(54) MICROFLUIDIC ASSEMBLY FOR SURFACE ACOUSTIC WAVE PARTICLE MANIPULATION

(71) Applicant: CYTONOME/ST, LLC, Bedford, MA (US)

(72) Inventors: Pascal Spink, Medford, MA (US); Kiryakos S. Mutafopulos, Somerville, MA (US)

(73) Assignee: CYTONOME/ST, LLC, Bedford, MA (US)

(21) Appl. No.: 17/697,462

(22) Filed: Mar. 17, 2022

Related U.S. Application Data
(60) Provisional application No. 63/162,300, filed on Mar. 17, 2021.

(51) Int. Cl. B01L 3/00; B06B 1/06; G01N 15/14

(52) U.S. Cl. CPC B01L 3/502715; B06B 1/0644; B01L 3/502707; B01L 3/502761; G01N 15/1404; G01N 15/1484; B01L 2200/0689; B01L 2300/06; B01L 2400/0436; B01L 2300/12; B01L 2200/0647; B01L 2200/12; G01N 2015/1081

(57) ABSTRACT

An apparatus for processing or manipulating or sorting particles by acoustic wave is disclosed. The apparatus can include a plastic or glass microfluidic channel or chip coupled via an intermediate layer to a piezoelectric substrate. The intermediate layer is acoustically matched to an acoustic wave produced in the piezoelectric substrate for manipulating and/or sorting particles in the microfluidic channel or chip. In some embodiments, the microfluidic channel or chip is coupled to a sealing layer through the intermediate layer. This multiple-layer assembly has higher yield and lower failure rate than conventional instruments and improves acoustic-wave propagation into the polymer or glass microchannel for the purpose of processing or manipulating or sorting particles or any combination thereof.

### CROSS-REFERENCE TO RELATED APPLICATIONS

This application claims priority to U.S. Provisional Application No. 63/162,300, filed Mar. 17, 2021, and the entire contents of this application is incorporated herein by reference.

### TECHNICAL FIELD

The present disclosure relates generally to devices, systems and techniques for manipulation of fluids including flow-focusing technology and microfluidics. The present disclosure relates more particularly to microfluidic systems and materials used to manipulate particles, cells and fluids.

### BACKGROUND

Systems and methods to separate specific particles from a heterogeneous particle population can operate on the detect/decide/deflect principle. In a microfluidic system, particles can be detected using, e.g., optical means as they flow in a microchannel. Characteristic properties of the particle can be identified based upon the detection methodology, and the decision can be made to select and separate the particle from the general population. The particle can then be deflected from the flow of particles and diverted, for example, to a specified storage area such as a predetermined branch of a microfluidic channel network.

### SUMMARY

An apparatus for manipulating and sorting particles by acoustic wave is disclosed. A multi-layered assembly couples a microfluidic channel formed in a plastic chip that is coupled with a piezoelectric substrate via an intermediate layer that is acoustically matched to an acoustic wave for manipulating particles or sorting particles or both as they flow in the microfluidic channel. A piezoelectric transducer is coupled with a sealing layer of the microfluidic chip through an intermediate layer. This multiple layer assembly enables propagation of acoustic-waves into a molded polymer microchannel for the purpose of manipulating particles, or sorting particles or both.

In some embodiments, an intermediate layer is in direct contact with the region of a piezoelectric substrate where an acoustic wave is generated. The acoustic wave transfers into and through the intermediate layer, which can be configured to optimize acoustic power transmission in relation to the Rayleigh angle. The intermediate layer is a waveguide positioned between a piezoelectric substrate and a sealing layer to enable acoustic wave propagation into a microchannel of a microfluidic chip. The intermediate layer may be matched to a specific acoustic impedance to ensure that acoustic waves are not reflected as they travel through one medium to the next. The matching of acoustic impedance between the piezoelectric substrate, intermediate layer and sealing layer maximizes efficient acoustic-wave propagation and minimizes reflection of acoustic waves at the juncture of layers.

The sealing layer, the intermediate layer, or both of the layers may be configured to optimally transmit acoustic waves at specific wavelengths. In some embodiments, the sealing layer, the intermediate layer, or both of the layers are thinner than 250 μm as thicker layers tend to attenuate or reflect acoustic waves. For example, a thickness of each of the sealing layer and the intermediate layer may be in a range from 10-250 μm, in a range from 10-100 μm, in a range from 60-140 μm, or in a range from 10-50 μm.

Coupling a piezoelectric substrate to a plastic microfluidic chip sealed by a sealing layer and employing an acoustically matched intermediate layer for acoustic wave propagation through plastic enables different microfluidic chips to be used on the same piezoelectric substrate. The multi-layer assembly serves to isolate the intermediate layer and the piezoelectric substrate from contamination by the contents inside the microchannel. The assembly also enables reuse of the piezoelectric substrate and the acoustically matched intermediate layer.

### BRIEF DESCRIPTION OF THE DRAWINGS

The accompanying drawings and description are illustrative, and not intended to define the limits of the invention.

FIG. 1 is a diagram of an example embodiment of a system according to the present disclosure, partially exploded.

FIG. 2 is a diagram of an example embodiment of a system according to the present disclosure depicting wave propagation.

FIGS. 3A-3D are photographs of an example embodiment of a system according to the present disclosure depicting wave propagation.

FIG. 4 is a perspective exploded view of an example test assembly according to the teachings of the present disclosure.

FIG. 5 is a perspective view of the assembled test assembly of FIG. 4.

FIG. 6A schematically illustrates a side view of an embodiment of the system including a bonding layer with an expanded view of a portion of the assembly in accordance with some embodiments of the present disclosure.

FIG. 6B illustrates a top view of the system embodiment in FIG. 6A.

FIG. 7 is a microscope image of a top view of a system as taught herein generating a surface acoustic wave.

FIG. 8 illustrates an exploded view of an assembly rig to assemble a microfluidic system according to various embodiments taught herein.

FIG. 9 illustrates an assembled view of the assembly rig of FIG. 8.

FIG. 10 illustrates a view of an IDT carrier according to some embodiments taught herein.

FIG. 11 illustrates a first subassembly 132 of the system including a top layer 140 in accordance with various embodiments taught herein.

FIG. 12 is a flowchart illustrating a method of assembling a microfluidic system in accordance with various embodiments taught herein.

FIG. 13 is a flowchart illustrating a method of use of the microfluidic system in accordance with various embodiments taught herein.

FIG. 14 schematically illustrates a computing device for use with some embodiments described herein.

FIG. 15 illustrates a side view of a particle processing system 70 including the microfluidic system as described herein in accordance with various embodiments.

### DETAILED DESCRIPTION

Apparatuses and methods for manipulating and sorting particles by acoustic wave, and their methods of manufacture, are disclosed herein. Systems and methods of the present disclosure couple a glass or plastic microfluidic substrate, such as a microfluidic chip or other structure featuring a microfluidic channel, to a piezoelectric substrate using an intermediate layer that is acoustically matched to an acoustic wave that travels within the piezoelectric substrate. This acoustic wave is used to manipulate or sort particles in the microfluidic substrate. For example, a piezoelectric transducer is coupled with an intermediate layer that is, in turn, coupled to a sealing layer. This multiple layer assembly enables acoustic-wave propagation into a molded polymer chip including a microchannel for the purpose of manipulating particles or sorting particles or both.

Systems and methods taught herein can be produced with higher manufacturing yield and lower failure rates than conventional devices. Conventionally, bonding glass or plastic substrates with microfluidic channels to a piezoelectric substrate such as lithium niobate poses challenges because the material property differences, coefficients of thermal expansion, and thermal conditions around the bonding process create incompatibilities that can result in incomplete bonding or early device failure. The coefficient of thermal expansion of lithium niobate, for example, is significantly larger than that of a conventional glass substrate. Different coefficients of expansion in the chip and piezoelectric substrate can introduce material stresses or strains that cause cracking or breakage during the bonding process, and the thermal cycling of the bonding process may also negatively affect the piezoelectric substrate.

The intermediate layer of certain systems and methods taught herein can simplify device assembly. The device including the intermediate layer can be assembled without the need for cleanroom tools such as wafer bonding tools. In some embodiments, alignment marks may be employed to enable alignment of the piezoelectric substrate to the microfluidic chip without the need for microscopes and precision stages to bring components precisely into contact. Because of incompatibilities between common cleanroom requirements and bonding equipment, it is difficult to bond a conventional plastic substrate to a piezoelectric substrate such as lithium niobate. For example, bonding equipment used in a cleanroom environment (e.g., to prepare micro-electro-mechanical systems or MEMS devices) works poorly with polymer or plastic materials because the material can melt or irreversibly contaminate the equipment. Moreover, wafer bonding often takes advantage of surface chemistry (e.g., in glass-glass, glass-silicon, or silicon-silicon bonding or plasma assisted bonding), an intermediate bonding layer such as a UV or thermal-curing adhesive, or a metal layer (e.g., eutectic bonding). Furthermore, conventional plastics used in microfluidic applications, such as cyclic olefin copolymer (COC) and cyclic olefin polymer (COP), are chemically inert and have low surface energy. These properties mean that such materials are difficult to adhere to other materials. The intermediate layer as taught herein can overcome these difficulties by improving acoustic impedance matching. Absent the intermediate layer, there is insufficient contact between the relatively hard layers (e.g., plastic, glass, or piezo substrate) to enable acoustic transmission between the IDT and the channel. In some embodiments, the intermediate layer is flexible or rubber-like and has increased contact surface with the microfluidic chip as compared to the bare IDT.

In some embodiments, systems in accordance with the present disclosure can be assembled without the use of direct liquid adhesive application on the chip by using the sealing layer and the intermediate layer. Direct adhesive bonding poses significant challenges. Although direct adhesive bonding can directly bond a conventional glass substrate with one or more microchannels to a lithium niobate piezoelectric substrate, for example, adhesive wicking into the microchannels can block the microchannels and lead to poor manufacturing yields. Moreover, acoustic waves generated into a substrate can cause thermal and mechanical stress that degrades certain adhesives and leads to eventual failure of the device by delamination or separation of the layers.

Other conventional efforts to address the material incapability between piezoelectric substrates and microfluidic substrates have resulted in formation of glass having a similar coefficient to a piezoelectric substrate to minimize mechanical stress in the bonding process. However, this approach leads to increased cost of manufacturing and channel-etching processes and requires a high degree of temperature and environmental control when transporting, storing, and using the resulting devices because significant temperature gradients may still cause stress fractures or other deleterious consequences.

Systems and methods of the present disclosure address issues of material incompatibility between piezoelectric substrates and microfluidic glass or plastic chips through use of an acoustically matched intermediate layer. By interposing an intermediate layer between the piezoelectric substrate and the microfluidic glass or plastic chips, the usual stress buildup at the interface between the substrate and chip arising from differences in thermal expansion is alleviated. The intermediate layer can reduce mechanical stress between the piezoelectric substrate and the microfluidic chip during bonding and during transmission of acoustic waves as the device is operated. In some embodiments, devices of the present disclosure can use conventional glass and plastic materials that are compatible with standard manufacturing and channel-etching processes.

Conventional systems exist for manipulation of fluids to form fluid streams of desired configuration, discontinuous fluid streams, particle streams, dispersions, etc., for purposes of fluid delivery, product manufacture, analysis, and the like. For example, highly monodisperse gas bubbles, less than 100 microns in diameter, have been produced using a technique referred to as capillary flow focusing. In this technique, gas is forced out of a capillary tube into a bath of liquid. The tube is positioned above a small orifice and the contraction flow of the external liquid through this orifice focuses the gas into a thin jet, which subsequently breaks into equal-sized bubbles via a capillary instability. In a related technique, a similar arrangement is used to produce liquid droplets in air.

Microfluidics is an area of technology involving fluid-flow control at a small scale. Microfluidic devices often include small-scale channels through which fluid flows, which can be branched or otherwise arranged to allow fluids to combine, or to divert fluids to different locations, or to cause laminar flow between fluids, or to dilute fluids, and the like.

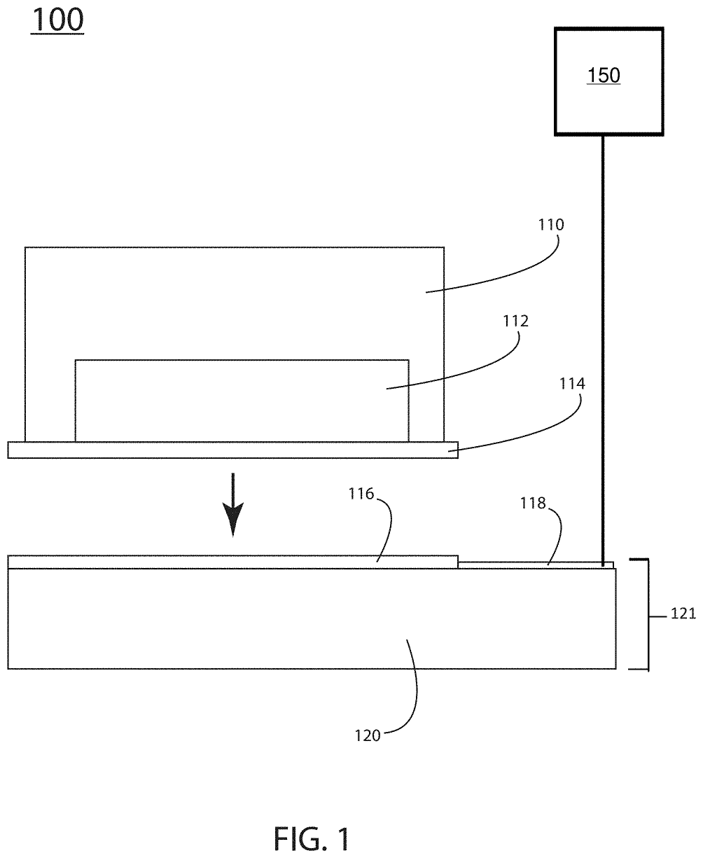

FIG. 1 illustrates a diagram of an example system 100. A microfluidic chip 110 includes a microfluidic channel 112. The microfluidic chip 110 and an open portion of the microfluidic channel 112 are sealed by a sealing layer 114. For example, the sealing layer 114 can be applied to a surface of the microfluidic chip 110. The microfluidic chip 110, sealed with the sealing layer 114, is contacted to an intermediate layer 116 coupled to a piezoelectric substrate 120. The contact between intermediate layer 116 and sealing layer 114 can be reversible in some embodiment. In some embodiments, the sealing layer 114 is adhered to the intermediate layer 116 using, for example, an adhesive. An arrow illustrates the assembly of the two subassemblies. At least a pair of electrodes 118 deposited on the piezoelectric substrate 120 together form an interdigital transducer (IDT) 121. The IDT 121 is connected to a computing device 150 that can include an integrated or external power supply to provide power to the electrodes 118. The IDT 121 generates surface acoustic waves (SAW) in response to a control signal or excitation signal applied to the electrodes 118 by the computing device 150.

In some embodiments, the microfluidic chip 110 is formed from a polymer. For example, the microfluidic chip 110 can include cyclic olefin polymer (COP) such as COP 1020R (Zeon Specialty Materials, Inc., San Jose, Calif.). The polymer for the microfluidic chip 110 includes properties that enable compatibility with cellular and biological particles. Polymer microfluidic chips can be easier to use in manufacturing and can be compatible with existing tooling and machinery. A polymer microfluidic chip can be lower in cost than other materials and, in some cases, can be manipulated (e.g., machined or fabricated) more easily than other materials to form the appropriate structural elements (e.g., microchannels, recesses to receive mounted components, etc.) for the completed device. In some embodiments, the microfluidic chip 110 is formed of a glass. The glass may have little to no piezoelectric properties. In some embodiments, the microfluidic channel 112 can be a groove cut or etched into the glass or plastic microfluidic chip 110 that guides the movement of particles in fluid for the purpose of manipulating or sorting the particles. The microfluidic chip 110 can include one or multiple microfluidic channels 112. Each microfluidic channel 112 can be associated with a separate IDT 121 (e.g., a separate set of electrodes 118) or a single set of electrodes 118 can produce surface acoustic waves for multiple microfluidic channels 112.

In some embodiments, the piezoelectric substrate 120 can be formed from one or more crystalline, ceramic, semiconductor, polymer or other materials that exhibits piezoelectric properties. In an exemplary embodiment, the piezoelectric substrate 120 is formed of lithium niobate (LiNbO₃). Lithium niobate is a manmade, dielectric material that is a compound of niobium, lithium and oxygen. Other appropriate materials can include lithium tantalate, quartz, potassium niobate, lead zirconate titanate, zinc oxide, bismuth titanate, barium titanate, zincblendes, wurtzites, and polyvinylidene fluoride (PVDF). In some embodiments, the piezoelectric substrate 120 includes 128° Y-X cut LiNbO₃.

In accordance with various embodiments, the sealing layer 114 can include a film, sheet, or other flexible layer configured to seal an open portion of the microfluidic chip 110. In some embodiments, the sealing layer 114 can be bonded to the microfluidic chip 110. For example, the sealing layer 114 could be bonded to the microfluidic chip 110 using solvent bonding. Solvent bonding can activates the surfaces on the film and the molded chip side with the channels to make them tacky before bonding them together under heat and pressure. In some embodiments, cyclohexane can be used as the solvent, which can be effective in some materials that are inert to other solvents. In other embodiments, pressure sensitive adhesive films or heat and pressure bonding can be used to bond the sealing layer 114 to the microfluidic chip 110. The bonding process can seal a surface of the sealing layer 114 to a surface of the microfluidic chip 110 to prevent fluids from flowing between the surface of the sealing layer 114 and the surface of the microfluidic chip 110. In some embodiments, the intermediate layer 116 can be pressed, joined, attached, or bonded to the sealing layer 114, to the piezoelectric substrate 120, or to both. The physical connection between the intermediate layer 116 and the sealing layer 114 can be permanent or temporary or, in other words, irreversible or reversible. In some embodiments, the sealing layer 114 can include a plastic film. For example, the sealing layer 114 can include a cyclic olefin copolymer (COC) such as COC 6013 or COC 8007 (TOPAS Advanced Polymers GmbH, Raunheim, Germany) in some embodiments. The material for the sealing layer 114 or microfluidic chip 110 can be transparent to enable optical transmission for detection of particles in the microfluidic channel. The materials for the sealing layer 114 or microfluidic chip 110 can be relatively chemically inert so that they are resistant to a range of solvents. The materials for the sealing layer or microfluidic chip 110 can have low water absorption characteristics to prevent swelling of the material or contamination of fluids in the channel. The materials for the sealing layer 114 or microfluidic chip 110 can allow for fine feature reproduction during injection molding or extrusion. A thickness of the sealing layer can be selected to balance strength (which tends to increase with thickness) against transmissivity of acoustic waves through the layer (which tends to decrease with thickness). In some embodiments, the thickness of the sealing layer 114 can be in a range from 10-250 micrometers or in a range from 60 to 140 micrometers. It can be advantageous to use a small thickness of the sealing layer 114 to reduce attenuation of the acoustic wave as it passes through the sealing layer 114.

In various embodiments, the intermediate layer 116 can include a single layer or multiple layers. In embodiments with multiple layers, each of the layers can include different material properties. For example, the multiple layers of the intermediate layer 116 can have different acoustic impedance properties to allow a step-wise or gradient transition from a starting acoustic impedance (i.e., the impedance of the piezoelectric substrate 120) to a final acoustic impedance (i.e., the impedance of the sealing layer 114 or the fluid in the microfluidic channel 112). In some embodiments, the intermediate layer 116 is polydimethylsiloxane (PDMS). In some embodiments, the intermediate layer 116 can include a water-based gel or gel pad to aid conduction of ultrasound waves. For example, the gel or gel pad is placed adjacent to the sealing layer 114 and forms part or all of the intermediate layer 116. Some gels can include polyvinyl alcohol (PVOH or PVA) or other water-soluble synthetic polymer. In some embodiments, the gel can be Aquasonic 100 (Parker Labs). The intermediate layer 116 can include a silicone grease, also known as dielectric grease, in some embodiments. Silicone grease is a waterproof grease made by combining a silicone oil with a thickener. A common silicone oil is polydimethylsiloxane (PDMS), and thickeners include amorphous fumed silica or stearates. In some embodiments, the intermediate layer 116 can include a composite of several materials. For example, the intermediate layer 116 can include a mixture of high acoustic impedance materials and low acoustic impedance materials such as a mixture of particles with a polymer. The intermediate layer 116 can act as a waveguide positioned between a piezoelectric substrate 120 and the sealing layer 114 to enable acoustic wave propagation into the microchannel 112 of the microfluidic chip 110. The material composition and shape of the intermediate layer may be tuned to a specific acoustic impedance to ensure that acoustic waves are not reflected as they travel from the piezoelectric substrate to the sealing layer 114 or microfluidic chip 110. The matching of acoustic impedance between the piezoelectric substrate 120, intermediate layer 116, and sealing layer 114 can improve efficient acoustic-wave propagation and reduce reflection of acoustic waves at the junctions between layers. Specifically, the total amount of acoustic wave energy reflected from an interface between the substrate 120 and the intermediate layer 116 and an interface between the intermediate layer 116 and the sealing layer 114 is less than the amount of acoustic wave energy reflected from a direct interface between the substrate 120 and the sealing layer 114 (i.e., in a system without the intermediate layer 116). In embodiments that include a bonding layer 125 as described below, the total amount of acoustic wave energy reflected from an interface between the substrate 120 and the bonding layer 125, in interface between the bonding layer 125 and the intermediate layer 116, and an interface between the intermediate layer 116 and the sealing layer 114 is less than the amount of acoustic wave energy reflected from a direct interface between the substrate 120 and the sealing layer 114.

A thickness of the intermediate layer 116 can be in a range from 5-250 micrometers, in a range from 5-150 micrometers, or in a range from 60-140 micrometers in various embodiments. A thin intermediate layer 116 can be preferable in some embodiments to reduce acoustic energy losses as the SAW energy traverses the intermediate layer 116. In some embodiments, the thickness of the intermediate layer 116 is dictated at least partially by the wavelength of the SAW. In some embodiments, the thickness of the intermediate layer 116 can be a whole or fractional multiple of the acoustic wavelength of the SAW. For example, the thickness of the intermediate layer 116 can be an integer number of wavelengths of the acoustic wave or, similarly, an integer number of wavelengths plus a fractional wavelength such as a quarter, third, or half-wavelength. In one embodiment, the thickness of the intermediate layer 116 is an integer number plus a quarter of a wavelength of the acoustic wave, i.e., thickness equals (n+1)*λ/4 where λ is the wavelength of the acoustic wave. Note that the wavelength of the acoustic compressional or longitudinal wave that is launched through the intermediate layer 116 at the Rayleigh angle can differ from the wavelength of the surface acoustic wave that is produced by the IDT 121. In some embodiments, the wavelength of the SAW produced by the IDT can be around 23 micrometers.

When power is supplied to the IDT 121, a surface acoustic wave is generated that is transmitted through several material junctions to arrive at the microfluidic chip 110. Junctions between dissimilar materials can produce impedance mismatches that generate the possibility of power reflection, thus reducing the total power that is transmitted to the microfluidic chip 110. When the acoustic impedance is badly mismatched at a junction, a greater amount of power must be supplied at the IDT 121 to achieve an acoustic wave of the desired intensity at the microfluidic chip 110. In some embodiments, the intermediate layer 116 and sealing layer 114 can act as an optimized waveguide that enables a reduction in power at the IDT to achieve a given intensity of acoustic wave as compared to a configuration without the intermediate layer 116. Besides the energy savings, driving lower power into the device can also reduce the amount of stress imposed on the components by the acoustic wave, which increases the device lifetime and reduces the likelihood of device failure.

In various embodiments, properties of the surface acoustic wave such as frequency, amplitude, and pulse width can be controlled by the IDT 121. The electrodes 118 of the IDT can include a contact pad portion for connection to a computing device 150 (including a power source) and an interdigitated portion where multiple extensions extend outward from the electrode 118. The extensions of one electrode can interleave or interdigitate with extension of another electrode. In some embodiments, the IDT is a component that can be separated or removed from the microfluidic chip, for example, for reuse. Various designs and configurations of IDT 121 are appropriate for use with embodiments of the present application. For example, the electrodes 118 of the IDT 121 can be tapered to enable the use of frequency tuning to cause the surface acoustic wave to appear at a particular location between the spaced electrodes. Additional electrode 118 and IDT 121 designs and configurations that are appropriate for use with embodiments of the present application can be found in U.S. Pat. No. 10,646,870 by Koksal et al., the entire contents of which is incorporated herein by reference.

In general, surface acoustic waves propagate along a stress free plane surface of an elastic solid substrate. Surface acoustic waves have an essentially exponential decay of amplitude into the substrate and therefore most of the displacement of the substrate occurs within about one wavelength of the surface. A surface acoustic wave may be generated using the IDT 121 including electrodes 118 forming a transducer supported by a piezoelectric substrate. For example, the transducer may be formed of two comb-shaped electrodes having interlocking teeth or fingers. An IDT converts periodically varying electrical signals into mechanical vibrations or acoustic waves able to travel along the surface of a material. The frequency of the SAW generated by an IDT may be controlled by controlling the periodic spacing of the teeth or fingers of the IDT. The frequency of a surface acoustic wave produced by an IDT 121 is proportional to (the speed of sound/(2*IDT finger spacing)). For this reason, IDTs 121 may be tapered to create a narrow position or aperture where surface acoustic waves are generated (the position with an IDT spacing corresponding to the driving signal frequency).

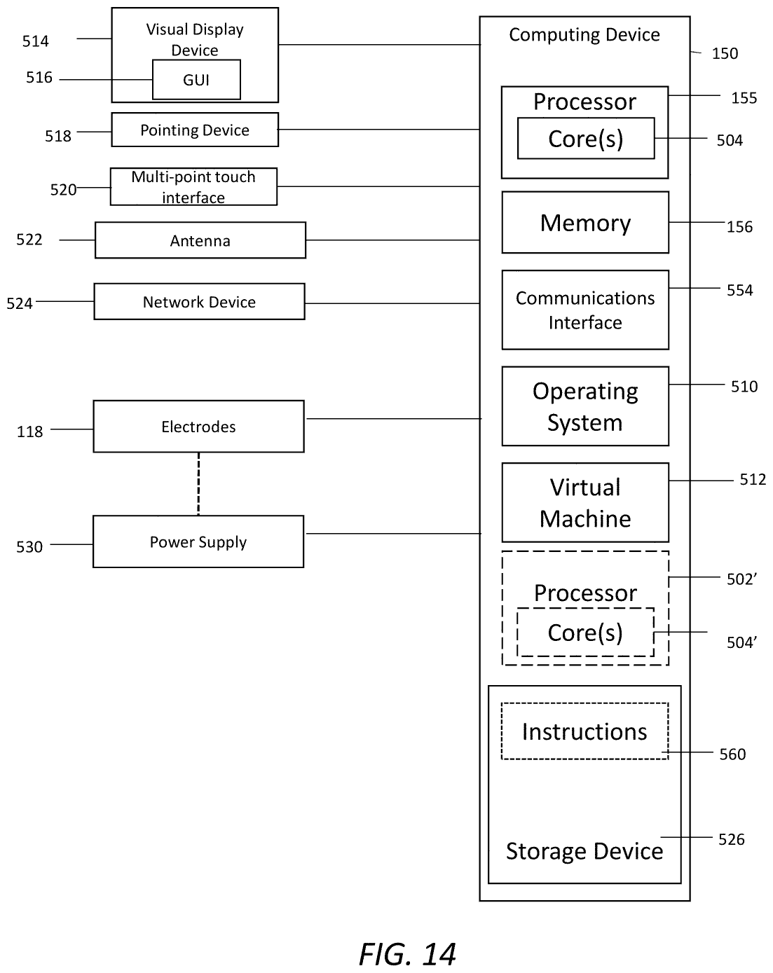

The IDT 121 can focus or deflect particles flowing in a fluid within the microfluidic channel 112. For example, the computing device 150 can receive optical measurement data for particles flowing in the microfluidic channel 112. At an appropriate time before the particle reaches a branching point in the microfluidic channel 112, the computing device 150 can send an electrical pulse to the electrodes 118 either directly or through a power supply, pulse generator, or other electrical amplifier. The electrical pulse is timed to cause the IDT 121 to create a surface acoustic wave as the particle passes near the position of the electrodes 118 in the system 100. The surface acoustic wave can impart a force on the particle to cause the particle to flow into a particular branch channel downstream of the branching point. An example of the computing device 150 suitable for use with systems and methods of this specification is described in greater detail with regards to FIG. 14.

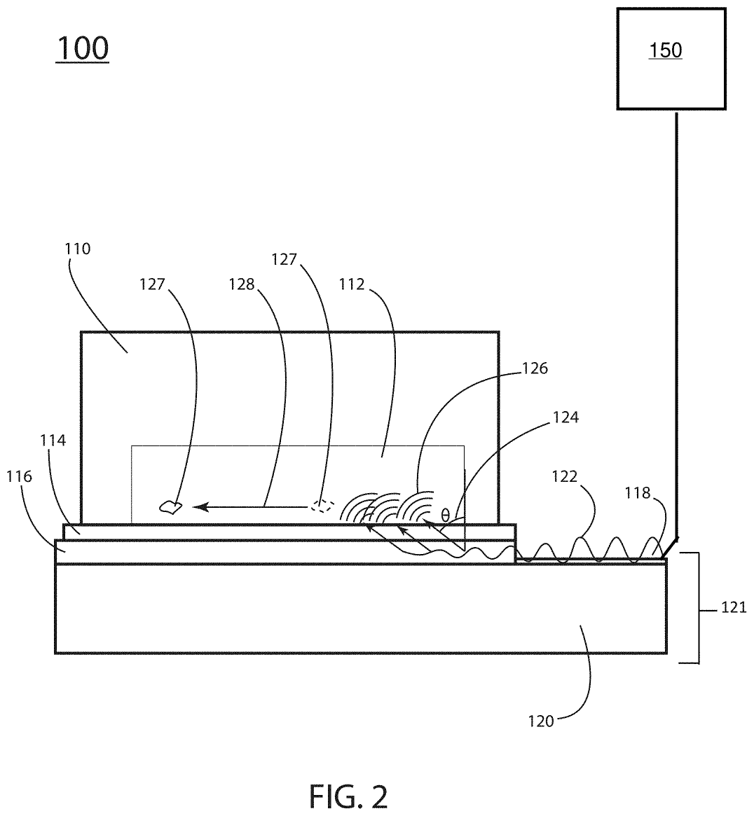

FIG. 2 illustrates a combination of the microfluidic chip 110 and an open portion of the microfluidic channel 112 sealed with the sealing layer 114 coupled with the IDT 121 via the intermediate layer 116. Surface acoustic waves (SAW) 122 are generated by the IDT 121 in response to a control signal or excitation signal. For example, the control signal or excitation signal can be provided by the computing device 150, pulse generator, or controller (not shown). The SAW 122 propagates into the intermediate layer 116 and deflects at a Rayleigh angle 124. Longitudinal acoustic waves 126 propagate through the sealing layer 114 and into the microfluidic channel 112. Upon interaction with longitudinal acoustic waves 126, a particle 127 is deflected along a path 128, moving the particle 127 to a second location.

The Rayleigh angle 124 depends on the speed of sound within the respective contacting material layers. In some embodiments, the system 100 has more than one Rayleigh angle 124 wherein each angle arises at interfaces between materials such as the interface from the IDT 121 to the intermediate layer 116, between multiple intermediate layers 116 (if applicable, between the intermediate layer 116 and the sealing layer 114, and between the sealing layer 114 and the liquid in the microfluidic channel 112 of the microfluidic chip 110. The Rayleigh angle 124 is measured from the vertical (i.e., z-axis, which is perpendicular to the layers in the stack) and becomes larger when the difference in the speed of sound of contacting layers becomes smaller. For example, the Rayleigh angle 124 between lithium niobate (c=3979 m/s) and water (c=1450 m/s) is approximately 22° resulting in a propagation vector that is almost vertical or perpendicular to the surface of the IDT. However, in an intermediate layer material with a higher speed of sound, the angle is larger resulting in a wave that is more horizontal directed relative to the surface and the propagation axis of the IDT 121. These vectors behave in a similar way as in optics and the assembly can result in a combination of angles at different interfaces of materials. In some embodiments, it is desirable to achieve a Rayleigh angle at the interface between the sealing film 114 and water (in the channel 112) that results in a forward-directed wave to push the particle horizontally as much as possible rather than vertically. In some embodiments, a Rayleigh angle 124 of, for example, 22° can have a sufficiently large horizontal component of the vector to deflect a particle in the fluid if the coupling between IDT 121 and microfluidic channel 112 is strong enough.

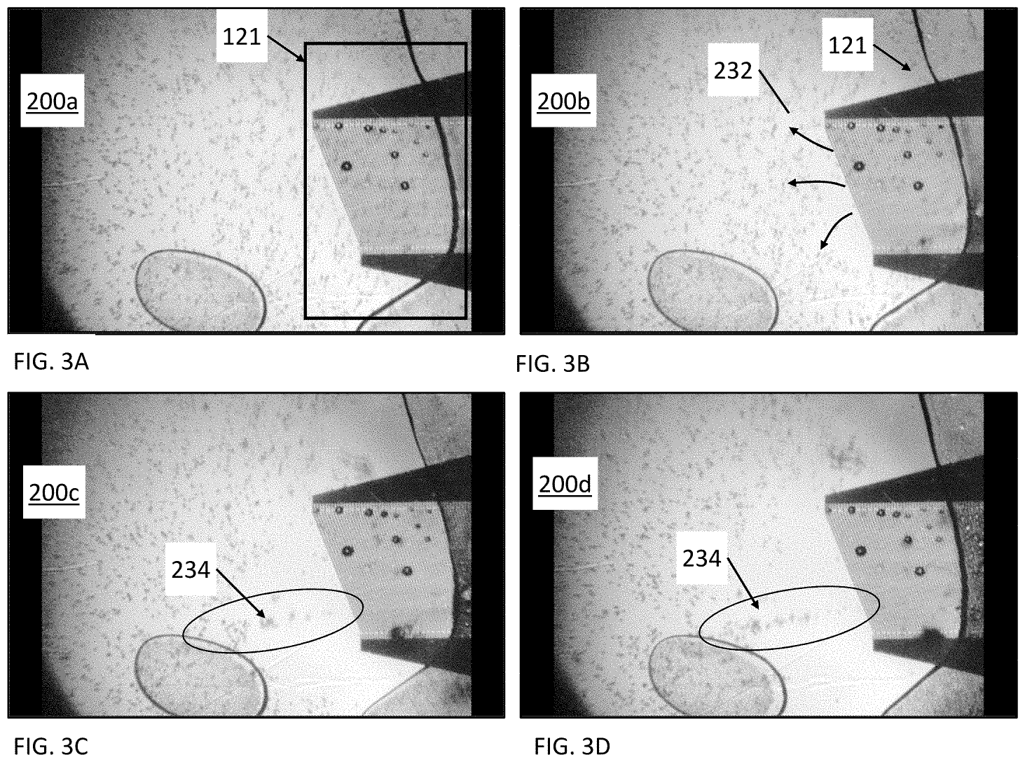

FIGS. 3A-3D are four images 200a-200d, respectively, depicting a demonstration of SAW actuation through a sealing layer 114 in the form of a film, with an acoustic gel used as an intermediate layer 116. In image 1, the IDT 121 is not actuated, and particles are randomly distributed within the depicted fluid volume. In image 2, the IDT 121 is actuated, and particles are being deflected away from the IDT 121 as depicted by arrows 232. Images 3 and 4 demonstrate continued actuation of the IDT 121 causing particles to move into a stream 234.

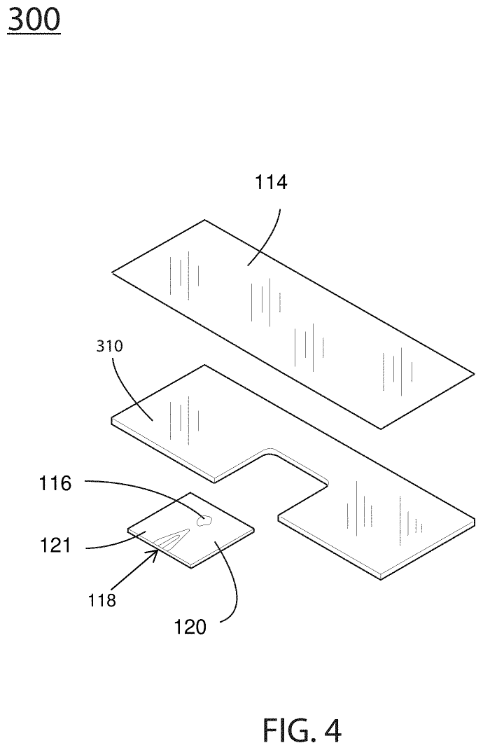

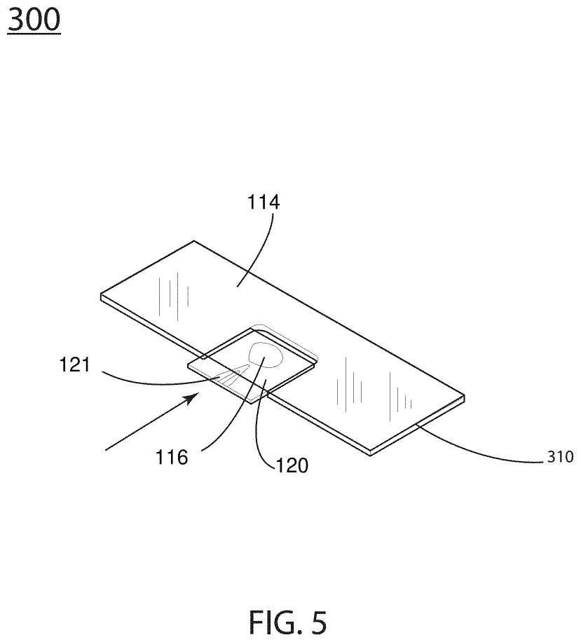

FIGS. 4 and 5 illustrate a test assembly 300 in exploded view (FIG. 4) and assembled (FIG. 5). The test assembly includes an alignment guide 310, a sealing layer 114, an IDT 121 including a piezoelectric substrate 120 and electrodes 118, and an intermediate layer 116 in the form of a sample of acoustic gel. As illustrated in FIGS. 4 and 5, the IDT 121 and intermediate layer 116 can fit into a notch in the alignment guide 310. The sealing layer 116 contacts the alignment guide 310 and the intermediate layer 116. After the test assembly 300 is assembled, actuation of the IDT 121 causes the acoustic gel 116 to spread out (FIG. 5). The test assembly 300 can be used to test transmission of acoustic waves through intermediate layers 116 and sealing layers 114 having different materials or thicknesses without needing fully-enclosed microfluidic chips. In some embodiments, a thickness of the alignment guide 310 and the thickness of the IDT are the same. In other embodiment, the thickness of the alignment guide 310 and the thickness of the IDT 121 can differ.

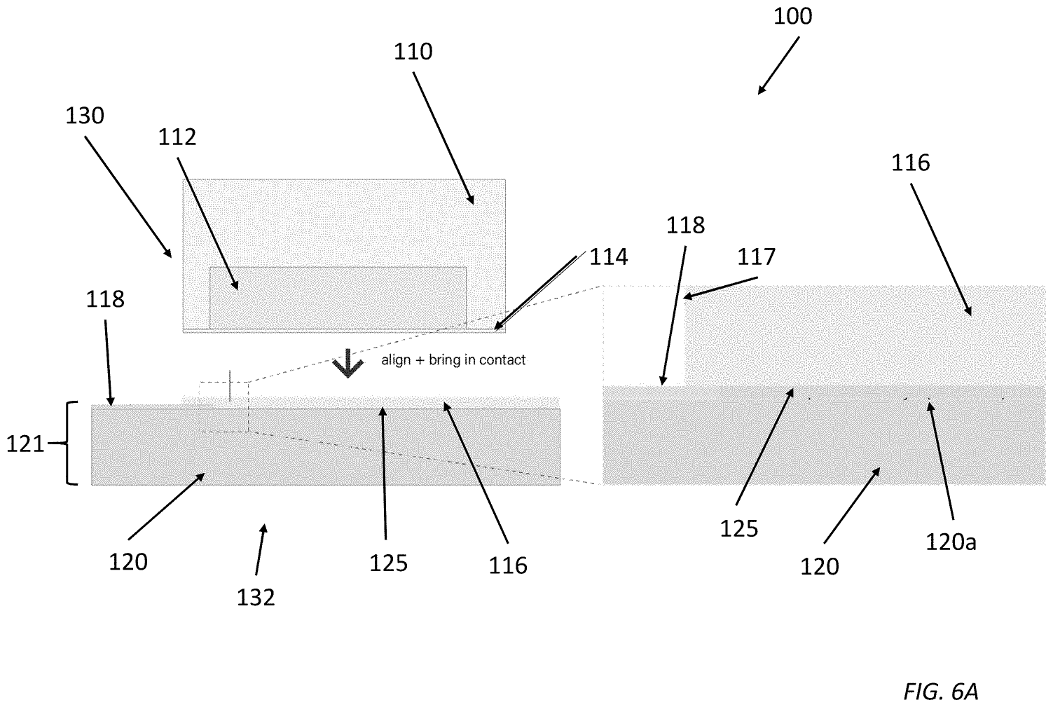

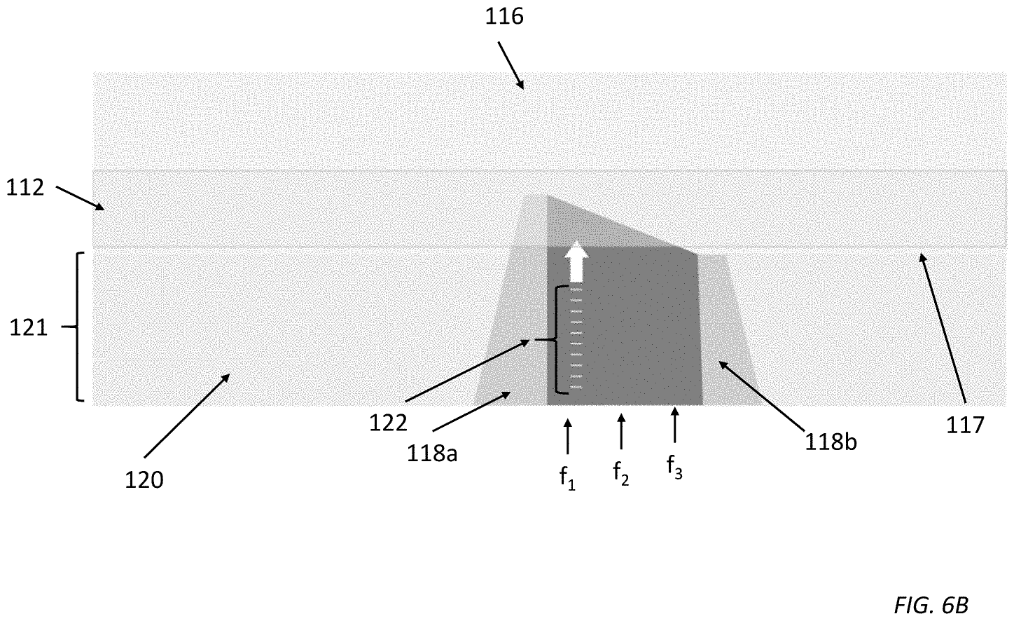

FIGS. 6A and 6B illustrate side and top views, respectively, of some embodiments of the system 100 including a bonding layer 125. In FIG. 6A, a portion of the figure is shown in an expanded view. In some embodiments, the system 100 includes the bonding layer 125 as taught herein. The bonding layer 125 lies between the intermediate layer 116 and the substrate 120 and facilitates bonding of the intermediate layer 116 to the substrate 120. In some embodiments, the bonding layer 125 is formed from silicon dioxide (SiO₂). In some embodiments, the intermediate layer 116 includes PDMS. In one embodiment, the silicon dioxide bonding layer 125 bonds tightly to the intermediate layer 116 made of PDMS. In some embodiments, a thickness of the bonding layer 125 is in a range from 50-100 nm.

As illustrated in FIG. 6A, the system 100 can be assembled into one or more sub-systems before final assembly. For example, the microfluidic chip 110 and the sealing layer 114 can be bonded or otherwise attached to each other to form a first subassembly 130. The IDT 121 (including substrate 120 and electrodes 118) and the intermediate layer 116 (and, in some embodiments, the bonding layer 125) can be combined to form a second subassembly 132. The first subassembly 130 and the second subassembly 132 can be aligned and brought into contact in some embodiments to form the system 100. The alignment and contacting of the first subassembly 130 to the second subassembly 132 can be done using an assembly jig 400 as described in greater detail below.

The bonding layer 125 can be joined, formed, or applied to a top surface 120a of the IDT 121. In various embodiments, the bonding layer 125 can be sputtered or grown (e.g., epitaxially) on the substrate 120 or can be fully formed separately from the substrate 120 and attached using a variety of chemical or mechanical means such as an adhesive. For example, the bonding layer 125 can be coated onto a top surface of the substrate 120 of the IDT 121 using RF sputtering such as by sputtering SiO₂ to form the bonding layer 125. During the application, deposition, or growth of the bonding layer 125, other components of the IDT 121 such as the electrodes 118 can be protected using, for example, a mask to prevent disruption of electrical conductivity for the electrodes 118. In other words, the bonding layer 125 can at least partially overlie electrodes 118 of the IDT in some embodiments while, in other embodiments, the electrodes 118 and bonding layer 125 can be separated or abutting without overlap. In embodiments where the bonding layer 125 overlies the electrodes 118, the bonding layer 125 can provide a barrier to prevent the intermediate layer 116 from electrically shorting the electrodes 118. This can be useful, for example, when the intermediate layer 116 is a liquid or gel. In some embodiments, the IDTs 121 can be formed together on a larger substrate that is then diced into separate IDTs 121 that are dimensioned for a carrier. In some embodiments, a length of the IDT can be about 14 mm or in a range from 6 mm to 20 mm. In some embodiments, a width of the IDT 121 can be about 8 mm or can be in a range from 4 mm to 12 mm. In some embodiments, the length and width dimensions of the IDT 121 match the same dimensions of the microfluidic chip 110.

In FIGS. 6A and 6B, it can be seen that the intermediate layer 116 overlies at least a portion of the electrodes 118 of the IDT 121. In other words, an interface 117 between the intermediate layer 116 and surrounding air is disposed over at least a portion of the electrodes 118 of the IDT 121. In embodiments of the IDT 121 that involve a taper (i.e., one electrode 118a extends closer in the direction towards the microfluidic channel 112 than the other electrode 118b), the interface 117 can extend to overlap the farther of the two electrodes in some embodiments. Placement of the interface 117 over at least a portion of the electrodes (to create overlap between the intermediate layer 116 and the electrodes 118) can advantageously improve coupling of the acoustic wave through the intermediate layer 116. In systems without overlap, the surface acoustic wave travels over the surface of the IDT and quickly begins decaying in intensity in free air. By overlapping the intermediate layer 116 with the electrodes 118 of the IDT 121, the SAW couples into the intermediate layer 116 as soon as it contacts the intermediate layer 118. As a result, more acoustic wave power can be transmitted into the intermediate layer 116 and thus to the microfluidic chip 110, which means that initial power at the IDT can be reduced. This reduction in total power reduces mechanical stress on the IDT and can increase lifetime of the system 100. In some embodiments, the lateral position of interface 117 directly overlies or is directly adjacent to an edge or tip of at least one of the electrodes 118. For example, the interface 117 in FIG. 6B is positioned directly adjacent to a tip of electrode 118b. In some embodiments, the smoothness or roughness of the interface 117 can be selected to improve acoustic wave coupling from the IDT 121 into the intermediate layer 116.

In some embodiments, the size and shape of the intermediate layer 116 create a localized “waveguide” effect. For example, the intermediate layer can have a length of about 5 mm and a width of about 2 mm.

The top view of FIG. 6B illustrates an embodiment where the IDT 121 includes tapered electrodes 118. Thus, if the IDT is driven at a first periodically varying frequency, f₁, only a first portion of the IDT generates a surface acoustic wave S₁. In the example actuation shown in FIG. 6B, the IDT 121 is being driven at the first frequency f₁ and produces a SAW 122 at the corresponding location where the spacing between interdigitated fingers matches the resonance condition. This produces the SAW 122 at a particular location along the microfluidic channel 112. When the IDT is driven at a second periodically varying frequency, f₂, only a second portion of the IDT generates a surface acoustic wave S₂. When the IDT is driven at a third periodically varying frequency, f₃, only a third portion of the IDT generates a surface acoustic wave S₃. It will be appreciate that the resonant excitation frequency can change continuously and monotonically from one electrode 118 to the other electrode 118 (e.g., between f₁ and f₃). In this way, the position along the microfluidic channel 112 where the surface acoustic wave is generated by the IDT 121 can be tuned by selection of the appropriate periodically varying frequency.

Fabrication of the intermediate layer 116 and fabrication of the second subassembly 132 can be accomplished in a number of ways consistent with the present disclosure. A particular fabrication process for the intermediate layer 116 from PDMS is described next, but one skilled in the art would appreciate that certain steps in the process can be modified or omitted depending upon the particular composition of the intermediate layer. In some embodiments, the PDMS can be mixed from two components: a monomer and a cross-linker. For example, a Sylgard® 184 silicone elastomer kit (Dow Chemical Company, Midland, Mich.) may be used. In various embodiments, the ratio of monomer to cross-linker can be selected to improve acoustic transmission. In some embodiments, the mixing ratio of monomer to cross-linker can be in a range from 10:1 down to 7:1. The mixture is degassed under vacuum to remove any mixed-in air. The mixture is then spun onto a silicon wafer covered with a plastic film. For example, the mixture can be spun on using a spin coater at 1000 rpm for 45 seconds. The use of a plastic film eases peel-off of the intermediate layer 116 in later steps. The spun wafer is baked (e.g., on a heat plate) for about 30 minutes at a temperature in a range from 65-95° C.

Once the PDMS is baked, a portion of the PDMS that forms the intermediate layer 116 is cut away, for example, by hand using a cutting instrument. In some embodiments, the size of the portion removed to form the intermediate layer 116 is about 2 mm×5 mm. The intermediate layer 116 is then treated using an oxygen plasma. For example, the plasma can be applied at about 20 ccm for 20 seconds at 50 W RF power. After plasma treatment, the intermediate layer 116 is brought into contact with the IDT 121 (described in greater detail below) for bonding. In some embodiments, the surface of the IDT 121 has also been plasma treated, e.g., using an oxygen plasma treatment, before coming into contact with the intermediate layer 116. The plasma treatment can enable covalent bonding between the piezoelectric substrate 120 and the intermediate layer 116. The IDT 121 can be bonded to the intermediate layer 116 with or without the bonding layer 125 according to various embodiments. A post-bonding heat treatment is applied wherein the intermediate layer 116 and IDT 121 are heated to about 65° C. for 20-30 minutes.

In an example embodiment, the first subassembly 130 and the second subassembly 132 can be joined permanently or temporarily. In other words, the first subassembly 130 and the second subassembly 132 can be irreversibly bonded or joined or, alternatively, can be reversibly joined. In some embodiments, the first subassembly 130 and second subassembly 132 are simply contacted to enable SAWs to pass from the IDT to the microfluidic channel 112. In embodiments where the intermediate layer has some elasticity or tackiness, the intermediate layer 118 can be frictionally joined to the sealing layer 114 of the first subassembly 130. The frictional bonding in some embodiments can include weak interactions that enhance contact adhesion, such as Van-der-Waals or dipole interactions, due to the polymer properties of PDMS and the oxygen groups present in the chip materials or piezoelectric substrate materials.

In embodiments where the joining between subassemblies is temporary, the first subassembly 130 can be a disposable portion of the system 100. Specifically, the first subassembly 130 can be attached to the second subassembly 132, a sample can be analyzed, and the first subassembly 130 can be removed and discarded. A new first subassembly 130 can then be used with the original second subassembly 132. The separability of the subassemblies and reusability of the second subassembly 132 is advantageous because the IDT 121 of the second subassembly 132 tends to be a more expensive part. In some embodiments, the second subassembly 132 (including the IDT 121 and the intermediate layer 116) can be provided as a sealed package with a protection layer that can be peeled off by the user immediately before installation. The protection layer can prevent contamination of the second subassembly 132 during shipment.

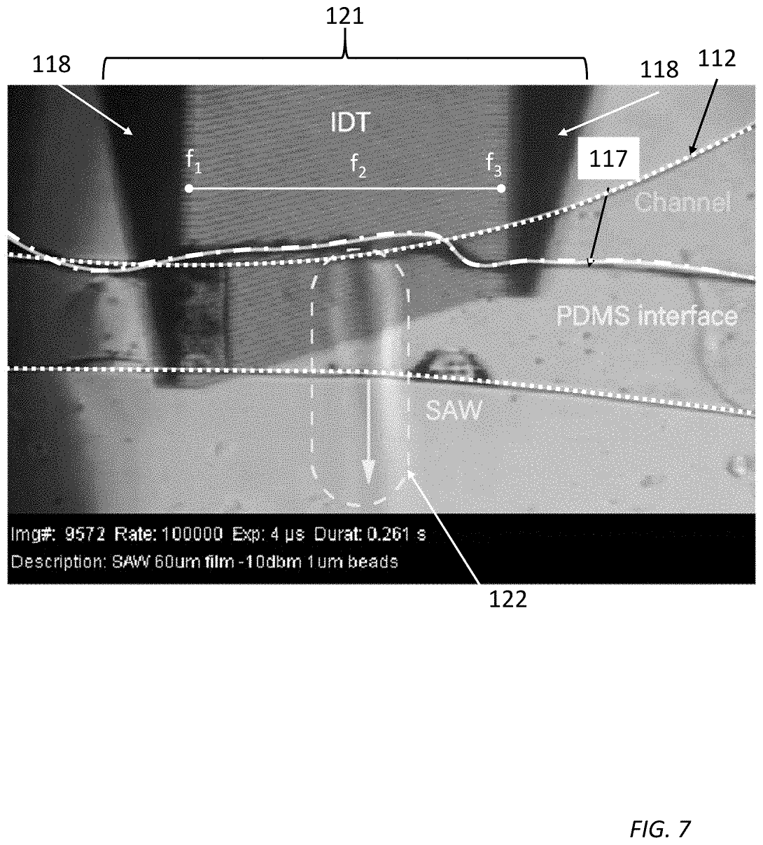

FIG. 7 illustrates a microscope image of a top view of a system according to the present disclosure that is being actuated at a periodically varying frequency f₂ to produce a surface acoustic wave (SAW) 122. In this image, the outline of the microfluidic channel 112 is indicated using dotted lines. The interior volume of the microfluidic channel 112 contains fluid. In addition, the interface 117 of the intermediate layer 116 is indicated using a dot-dash line. The interface 117 is disposed at least partially over the electrodes 118, and the electrodes 118 underlie the intermediate layer 116 and the microfluidic channel 112. The IDT 121 was actuated at the time this image was taken, and the compressional wave produced in the channel fluid by the SAW 122 is visible as a streak. The streak is visible to the eye because the fluidic disturbance has a different reflectivity to the surrounding fluid.

Similar to the IDT 121 depicted in FIG. 6B, the electrodes 118 of the IDT 121 in the image of FIG. 7 are tapered. As such, the IDT 121 can be controlled by the computing device 150 to emit a SAW at a specific position along the microfluidic channel 112 when the computing device 150 excites the electrodes 118 with an electrical signal at a particular frequency. For example, a signal at a first periodically varying frequency f₁ will cause the SAW to be emitted at the left side of the electrodes 118 while a signal at a periodically varying frequency f₃ causes emission of the SAW at the right side of the electrodes 118.

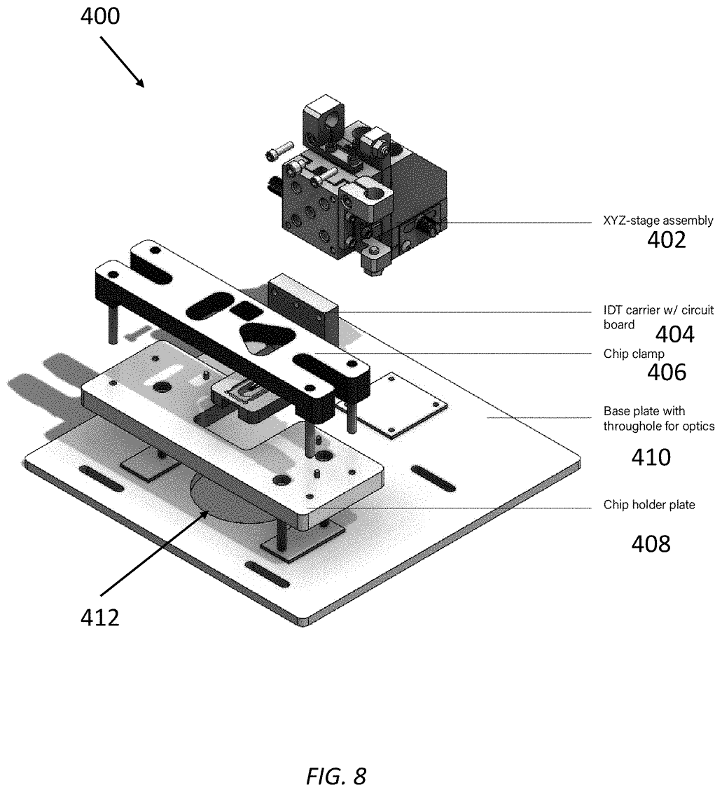

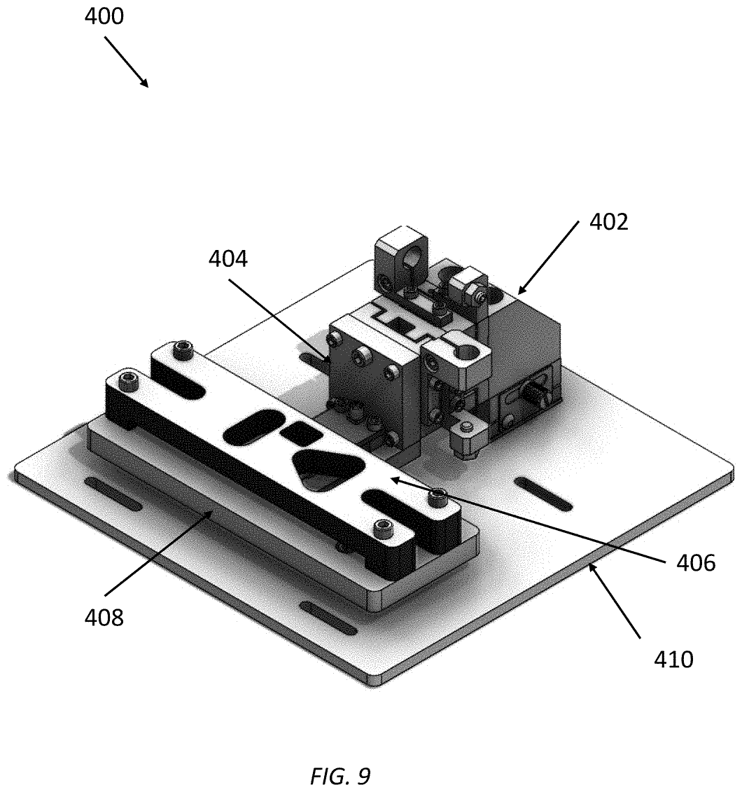

FIGS. 8 and 9 illustrate exploded and assembled views, respectively, of an assembly jig 400 to facilitate assembly of the microfluidic systems 100 as taught herein. The assembly jig 400 includes an XYZ-stage assembly 402, an IDT carrier with circuit board 404, a chip clamp 406, and a chip holder plate 408. In some embodiments, the assembly jig 400 includes a base plate 410 to which the other components are mounted and which includes a through hole 412 for optics. The assembly jig 400 streamlines alignment of various parts of the system 100 during fabrication.

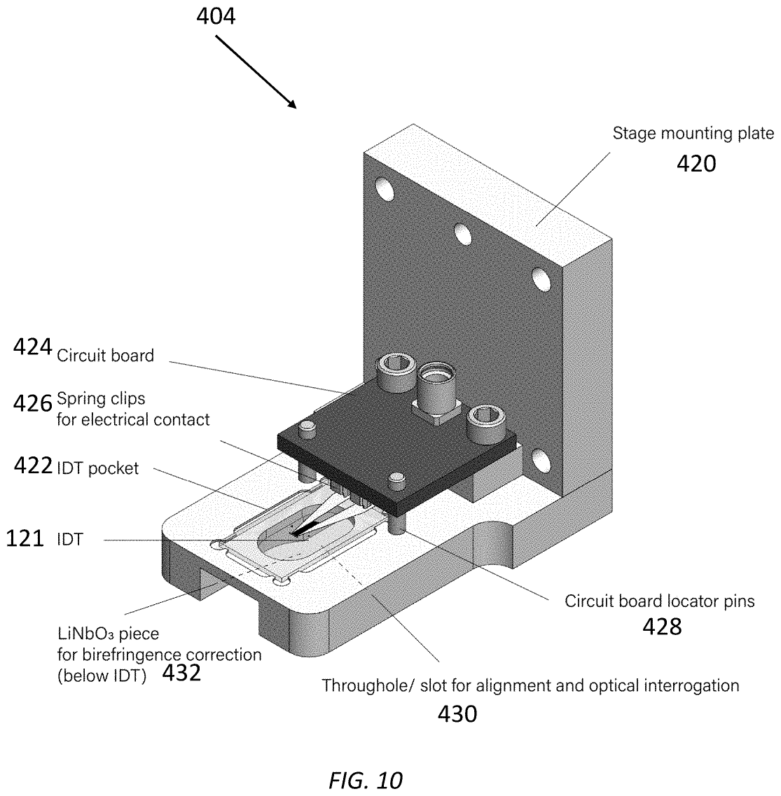

FIG. 10 illustrates the IDT carrier 404 in greater detail including an IDT 121 mounted thereon. In some embodiments, the IDT carrier 404 is a milled aluminum piece. The IDT carrier 404 can be mounted to the XYZ-stage assembly 402 using a stage mounting plate 420. The IDT carrier 404 can include an IDT pocket 422 that is precisely milled to the dimensions of the IDT 121 so that the IDT 121 stays in place. Spring clips 426 can make electrical contact with the electrodes 118 of the IDT 121 when the IDT 121 is mounted on the IDT carrier 404. A circuit board 424 mounted on circuit board locator pins 428 can power the electrodes 118 of the IDT 121 through the spring clips 426. When the IDT carrier 404 is mounted to the XYZ-stage assembly 402 and the base plate 410, a through hole 430 of the IDT carrier 404 aligns with the through hole of the base plate 410 to enable optical alignment of the system elements (e.g., first subassembly 130 and second subassembly 132) and particle interrogation during use of the system 100. The IDT carrier 404 can include an aberration correction element 432 in some embodiments. Some piezoelectric substrate 120 materials such as lithium niobate have optical properties, such as birefringence, that create aberrations for optical imaging such as double images. The aberration correction element 432 corrects the aberrations introduced by the piezoelectric substrate 120. For example, the aberration correction element 432 can include a piece of similar material properties as the piezoelectric substrate 120 but oriented in the opposite direction to “undo” the aberrations introduced by the piezoelectric substrate 120.

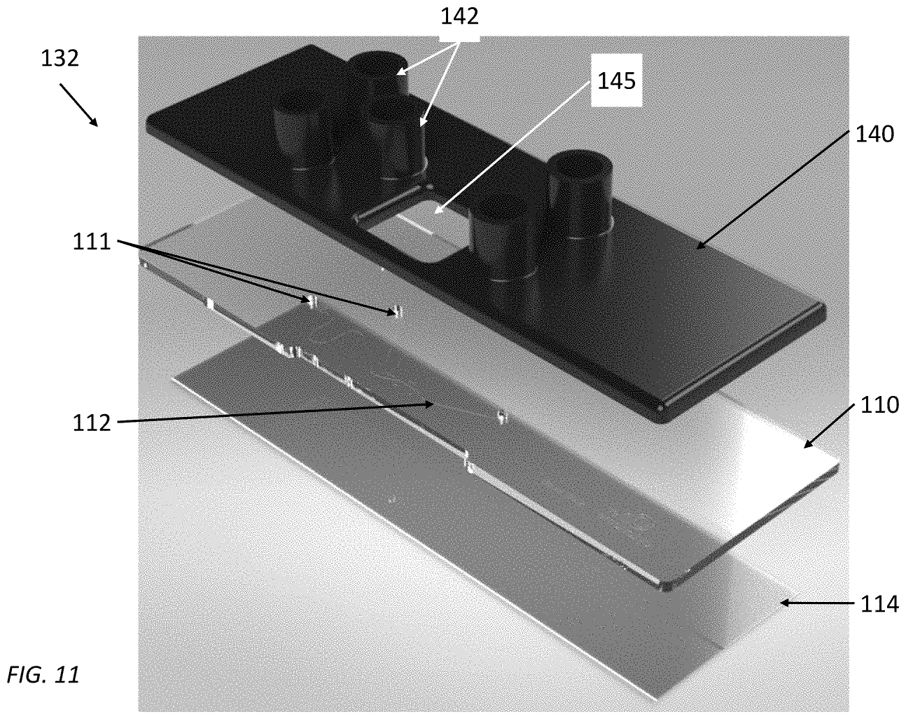

FIG. 11 illustrates a first subassembly 132 of an embodiment of the system 100 of the present disclosure including a top layer 140. The top layer 140 can include an aperture 145 and fluid ports 142. In an example embodiment, the fluid ports 142 of the top layer 140 align with port through holes 111 in the microfluidic chip 110. The port through holes 111 are in fluid communication with the one or more microfluidic channels 112 in the microfluidic chip 110. The fluid ports 142 are configured to receive tubing or similar fluid conduits that can carry fluid such as sample fluid or sheath fluid. The fluid ports 142 and port through holes 111 are aligned to enable insertion of fluid (that may include particles) into the microfluidic channels 112 or to enable withdrawal of fluid (that may include particles) from the microfluidic channels 112. A portion of the one or more microfluidic channels 112 can be observed through the aperture 145. Thus, the aperture 145 allows for illumination of the microfluidic channels 112 (and any fluids or particles therein) or detection of light emitted from particles in the microfluidic channels 112 during operation. In some embodiments, the top layer 140 is laser welded to the microfluidic chip 110. The top layer 140 can be formed from a range of materials including glasses and plastics. The top layer 140 can be formed of materials that are transparent to light or opaque to one or more frequencies or ranges of frequencies of light. In an example embodiment, the top layer includes cyclic olefin polymer such as COP 1020R Black. In some embodiments, the first subassembly 130 is assembled and sold as a consumable part that can be placed into contact with the second subassembly 132, used for particle processing, and discarded after use.

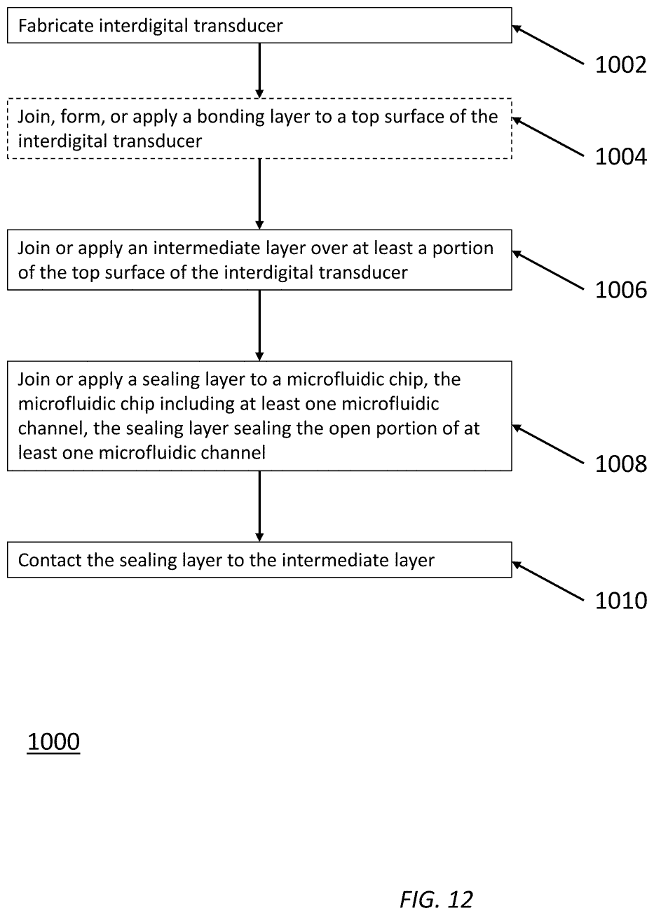

FIG. 12 is a flowchart illustrating a method 1000 of assembling a microfluidic system in accordance with various embodiments taught herein. The method 1000 includes fabricating the interdigital transducer or IDT 121 (step 1002). For example, the IDT can be fabricated using a standard liftoff process in a cleanroom setting. The method 1000 also includes an optional step of joining, forming, or applying a bonding layer to a top surface of the IDT 121 (step 1004). For example, the bonding layer 125 can be sputtered or grown epitaxially or otherwise on the top surface of the IDT 121. The method 1000 includes joining or applying an intermediate layer 116 over at least a portion of the top surface of the IDT 121 (step 1006). For example, the intermediate layer 116 can be spin-coated or deposited onto the top surface of the IDT in some embodiments. In some embodiments, the intermediate layer 116 can be spin-coated or deposited onto the bonding layer 125 that is over the top surface 120a of the IDT 121.

The method 1000 also includes joining or applying a sealing layer 114 to a microfluidic chip 110 (step 1008). The microfluidic chip 110 includes at least one microfluidic channel 112, and the sealing layer 114 seals the open portion of at least one microfluidic channel. For example, the sealing layer 114 can be solvent bonded to the microfluidic chip 110 to seal the microfluidic channel 112 such that liquids cannot escape to the edges of the microfluidic chip between the surface of the microfluidic chip 110 and the sealing layer 114. The method also includes contacting the sealing layer 114 to the intermediate layer 116 (step 1010). For example, the sealing layer 114 can be contacted to the intermediate layer 116 under pressure to cause adhesion between the layers to form a unitary system.

In some embodiments, an assembly jig 400 such as that described in relation to FIGS. 8-10 may be used to facilitate one or more steps of the method 1000. For example, the assembly rig 400 can be used to align components before they are joined.

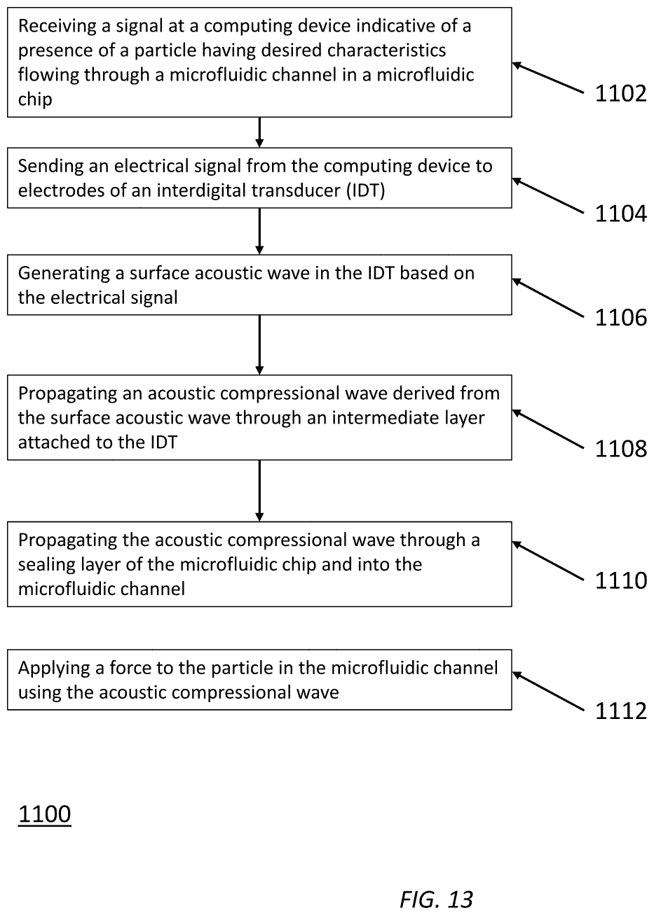

FIG. 13 is a flowchart illustrating a method 1100 of use of the microfluidic system 100 in accordance with various embodiments taught herein. The method 1100 includes receiving a signal at a computing device 150 indicative of a presence of a particle having desired characteristics flowing through a microfluidic channel 112 in a microfluidic chip 110 (step 1102). For example, the signal can be generated by a detector that receives light (e.g., scattered, emitted, or fluoresced light) or the absence of light (e.g., background signal is reduced due to extinction or absorption of light) from the particle. The computing device 150 can make a determination based on the received signal as to whether to allow the particle to continue on the same fluid stream or whether to divert the particle to a different channel downstream of a branching point in the microfluidic channel 112. In some embodiments, the computing device 150 can use the detect/decide/deflect principle when evaluating particles to determine whether to take further action.

When the particle with desired characteristics is detected by the computing device 150 and diversion of the particle is desired, the computing device sends an electrical signal to electrodes 118 of the IDT 121 (step 1104). The computing device 150 can send electrical signals directly to the electrodes 118 or can control a function generator, signal generator, or power supply to deliver electrical signals to the IDT 121.

The method 1100 includes generating a surface acoustic wave in the IDT 121 based on the electrical signal (step 1106). The method 1100 includes propagating an acoustic compressional wave derived from the surface acoustic wave through an intermediate layer attached to the IDT (step 1108). The acoustic compressional wave arises from deflection or scattering of the surface acoustic wave at the interface between the IDT 121 and the intermediate layer 118. As the scattered or deflected wave is no longer traveling on the surface, it is now more properly termed as an acoustic compressional or longitudinal wave. The method 1100 includes propagating the acoustic compressional wave through a sealing layer 114 of the microfluidic chip and into the microfluidic channel 110 (step 1110). The method 1100 includes applying a force to the particle in the microfluidic channel 110 using the acoustic compressional wave (step 1112). Examples of this force are shown above with respect to FIGS. 2 and 3, for example.

FIG. 14 is a block diagram of a computing device 150 suitable for use with embodiments of the present disclosure. The computing device 150 may be, but is not limited to, a smartphone, laptop, tablet, desktop computer, server, or network appliance. The computing device 150 includes one or more non-transitory computer-readable media for storing one or more computer-executable instructions or software for implementing the various embodiments taught herein. The non-transitory computer-readable media may include, but are not limited to, one or more types of hardware memory (e.g., memory 156), non-transitory tangible media (for example, storage device 526, one or more magnetic storage disks, one or more optical disks, one or more flash drives, one or more solid state disks), and the like. For example, memory 156 included in the computing device 150 may store computer-readable and computer-executable instructions 560 or software (e.g., instructions to process particles as in the method 1100) for implementing operations of the computing device 150. The computing device 150 also includes configurable and/or programmable processor 155 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 156 and other programs for implementing embodiments of the present disclosure. Processor 155 and processor(s) 502′ may each be a single core processor or multiple core (504 and 504′) processor. Either or both of processor 155 and processor(s) 502′ may be configured to execute one or more of the instructions described in connection with computing device 150.

Virtualization may be employed in the computing device 150 so that infrastructure and resources in the computing device 150 may be shared dynamically. A virtual machine 512 may be provided to handle a process running on multiple processors so that the process appears to be using only one computing resource rather than multiple computing resources. Multiple virtual machines may also be used with one processor.

Memory 156 may include a computer system memory or random access memory, such as DRAM, SRAM, EDO RAM, and the like. Memory 156 may include other types of memory as well, or combinations thereof.

A user may interact with the computing device 150 through a visual display device 514, such as a computer monitor, which may display one or more graphical user interfaces 516. The user may interact with the computing device 150 using a multi-point touch interface 520 or a pointing device 518.

The computing device 150 may also include one or more computer storage devices 526, such as a hard-drive, CD-ROM, or other computer readable media, for storing data and computer-readable instructions 560 and/or software that implement exemplary embodiments of the present disclosure (e.g., applications). For example, exemplary storage device 526 can include instructions 560 or software routines to enable data exchange with detectors or light sources as in the system 700 described below or instructions to execute particle processing methods such as method 1100.

The computing device 150 can include a communications interface 554 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 150 can include one or more antennas 522 to facilitate wireless communication (e.g., via the network interface) between the computing device 150 and a network and/or between the computing device 150 and components of the system such as the electrodes 118 or power supply 530. The communications interface 554 may include a built-in network adapter, network interface card, PCMCIA network card, card bus network adapter, wireless network adapter, USB network adapter, modem or any other device suitable for interfacing the computing device 150 to any type of network capable of communication and performing the operations described herein.

In some embodiments, the power supply 530 can be connected directly to the electrodes 118. In some embodiments, the power supply 530 is a component of the computing device 150 that is in the same housing as other elements of the computing device 150. In other embodiments, the power supply 530 (which may also be referred to as a pulse generator) is a standalone device that is controlled by the computing device 150.

The computing device 150 may run an operating system 510, such as versions of the Microsoft® Windows® operating systems, different releases of the Unix® and Linux® operating systems, versions of the MacOS® for Macintosh computers, embedded operating systems, real-time operating systems, open source operating systems, proprietary operating systems, or other operating system capable of running on the computing device 150 and performing the operations described herein. In exemplary embodiments, the operating system 510 may be run in native mode or emulated mode. In an exemplary embodiment, the operating system 510 may be run on one or more cloud machine instances.

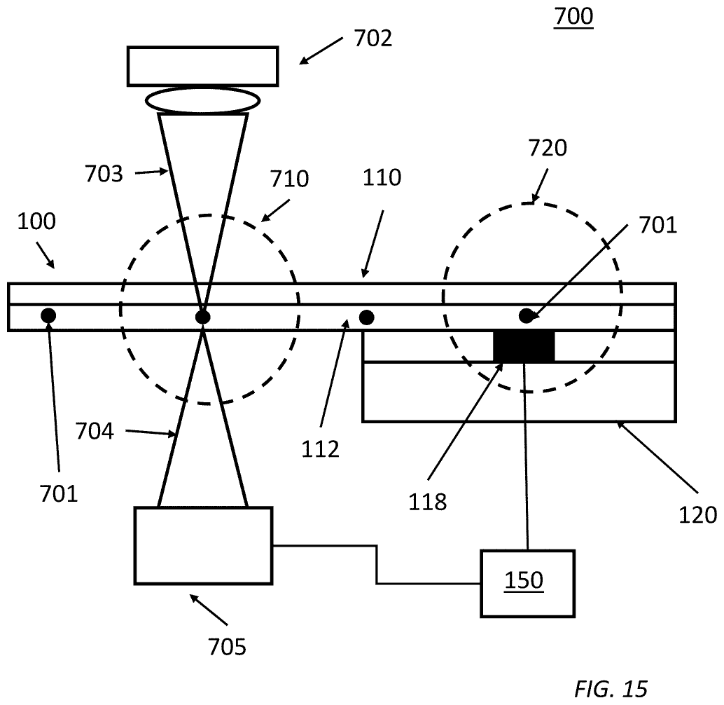

FIG. 15 illustrates a side view of a particle processing system 700 including the microfluidic system 100 as described herein in accordance with various embodiments. The system 700 includes a light source 702 and a detector 705 that interface with the system 100. The microfluidic chip 110 can include an interrogation region 710 where particles 701 flowing in the microfluidic channel can be interrogated by light emitted from the light source 702. Light that is emitted or scattered from the particles 701 is received at a detector 705. The detector 705 can send signals to the computing device 150 that are indicative of particles 701 having, or lacking, desired particle characteristics. The particles 701 then flow downstream in the microfluidic channel 112 and pass through the sorting region 702. In the sorting region 702, the computing device 150 can control the IDT 121 to emit a surface acoustic wave that results in a force being applied to the particle 701. The particle 701 can be diverted into a branch channel (not shown in the side view of FIG. 15 as the branch lies into or out of the page of the drawing) by the applied force. The particle processing system 700 is appropriate for use with the method 1100 described in this application. Additional system components and methods for detecting, focusing, selecting, and diverting particles having desired characteristics are found in U.S. Pat. No. 7,569,788, issued Aug. 4, 2009; U.S. Pat. No. 7,157,274, issued Jan. 2, 2007; U.S. Pat. No. 10,646,870, issued May 12, 2020; and U.S. Pat. No. 10,960,396, issued Mar. 30, 2021, the entire contents of each of the above documents being incorporated herein by reference.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

1. A microfluidic system for processing particles, comprising:
a microfluidic chip including a microfluidic channel;
a sealing layer covering an open portion of the microfluidic channel and a portion of the microfluidic chip;
an interdigital transducer (IDT) including electrodes and a piezoelectric substrate; and
an intermediate layer disposed between the sealing layer and the piezoelectric substrate, the interdigital transducer generating surface acoustic waves that couple into the microfluidic channel through the intermediate layer, the intermediate layer overlies at least a portion of the electrodes of the IDT.

2. The microfluidic system of claim 1, wherein the microfluidic chip is formed of a polymer.

3. The microfluidic system of claim 1, wherein the microfluidic chip is formed of a glass.

4. The microfluidic system of claim 1, wherein the sealing layer seals the open portion of the microfluidic channel.

5. The microfluidic system of claim 1, wherein the piezoelectric substrate is formed at least in part of lithium niobate.

6. The microfluidic system of claim 1, wherein the intermediate layer and the sealing layer match the acoustic impedance of the piezoelectric substrate to reduce reflection of acoustic waves at interfaces between the intermediate layer, sealing layer, and piezoelectric substrate.

7. The microfluidic system of claim 1, wherein the intermediate layer includes an acoustic gel.

8. The microfluidic system of claim 1, wherein the interdigital transducer is a component that can be separated or removed from the microfluidic chip.

9. The microfluidic system of claim 1, wherein the intermediate layer includes polydimethylsiloxane.

10. The microfluidic system of claim 1, further comprising a bonding layer disposed between the piezoelectric substrate and the intermediate layer.

11. The microfluidic system of claim 10, wherein a thickness of the bonding layer is in a range of 50 to 100 nanometers.

12. The microfluidic system of claim 10, wherein the bonding layer includes silicon dioxide.

13. A method of manufacturing a microfluidic system, comprising:
applying an intermediate layer over a top surface of a piezoelectric substrate of an interdigital transducer (IDT), the intermediate layer overlying at least a portion of one or more electrodes of the IDT;
applying a sealing layer to a surface of a microfluidic chip having a microfluidic channel; and
contacting the sealing layer to the intermediate layer to form the microfluidic system.

14. The method of claim 13, wherein the intermediate layer is an acoustic gel, the method further comprising actuating the interdigital transducer to spread out the acoustic gel.

15. The method of claim 13, further comprising disposing a bonding layer between the piezoelectric substrate and the intermediate layer.

16. The method of claim 15, wherein disposing the bonding layer includes depositing a layer of silicon dioxide over at least a portion of the piezoelectric substrate; and
wherein applying the intermediate layer includes spin-coating a layer of polydimethylsiloxane over the bonding layer.

17. The method of claim 15, wherein applying the sealing layer includes solvent bonding the sealing layer to the surface of the microfluidic chip.

18. A method of using a microfluidic system to apply a force to a particle in a fluidic stream, comprising:
receiving a signal at a computing device indicative of a presence of a particle having desired characteristics flowing through a microfluidic channel in a microfluidic chip;
sending an electrical signal from the computing device to electrodes of an interdigital transducer (IDT);
generating a surface acoustic wave in the IDT based on the electrical signal;
propagating an acoustic compressional wave derived from the surface acoustic wave through an intermediate layer attached to the IDT, the intermediate layer overlying at least a portion of the electrodes;
propagating the acoustic compressional wave through a sealing layer of the microfluidic chip and into the microfluidic channel; and
applying a force to the particle in the microfluidic channel using the acoustic compressional wave.

19. The method of claim 18, further comprising selecting a frequency for the electrical signal using the computing device, the frequency selected to actuate a portion of the IDT.

20. The method of claim 18, wherein receiving the signal at the computing device includes receiving the signal from an optical detector that receives fluorescent light emitted from the particle.
